(19) United States
(12) Patent Application Publication
(10) Pub. No.: US 2015/0380831 A1
(43) Pub. Date: Dec. 31, 2015

(54) ANTENNA EQUIPPED WITH VERTICALLY ARRANGED RADIATING ELEMENTS

(71) Applicant: KMW INC., Hwaseong (KR)

(72) Inventors: Young-Chan Moon, Suwon (KR); Sung-Hwan So, Hwaseong (KR); In-Ho Kim, Yongin (KR); Oh-Seog Choi, Hwaseong (KR)

(73) Assignee: KMW INC.

(21) Appl. No.: 14/832,605

(22) Filed: Aug. 21, 2015

Related U.S. Application Data
(63) Continuation of application No. PCT/KR2014/001809, filed on Mar. 5, 2014.

(30) Foreign Application Priority Data
Mar. 6, 2013 (KR) 10-2013-0024044

(51) Int. Cl. H01Q 19/10; H01Q 1/12

(52) U.S. Cl. CPC H01Q 19/104; H01Q 1/12

(57) ABSTRACT

The present invention relates to a base station antenna for mobile communication, the antenna, equipped with vertically arranged radiating elements and connected to a base station system, comprising: a reflective plate disposed in the interior of the antenna; a plurality of radiating elements disposed on the planar surface of the reflective plate; and a moving unit for moving the plurality of radiating elements vertically within the range of the planar surface of the reflective plate.

### CROSS REFERENCE TO RELATED APPLICATIONS

This application is a continuation of International Application No. PCT/KR2014/001809 filed on Mar. 5, 2014, which claims priority to Korean Application No. 10-2013-0024044 filed on Mar. 6, 2013, which applications are incorporated herein by reference.

### TECHNICAL FIELD

The present invention relates to a base station antenna for mobile communication and, more specifically, to an antenna equipped with vertically arranged radiating elements that can adjust the vertical arrangement of the radiating elements thereof

### BACKGROUND ART

In recent years, mobile communication service providers have provided a multi-service band to mobile communication subscribers, and, accordingly, broadband antennas that have a wide frequency range have been required in mobile communication antenna markets.

Conventional broadband antennas developed in response to the requirement have been designed to operate in a broad band. However, radiating elements thereof are vertically arranged at moderate intervals rather than optimal intervals so that the radiating elements fail to optimally operate in actual frequencies.

For example, since all code division multiple access (CDMA) types of base stations use the same frequency assignment (FA), optimization to adjust at least four or five base stations on a cluster basis is consistently required to reduce inter-cell pseudo-noise (PN) interference.

Although the gain of an antenna increases by about 3 dB (twice) in the same structure as a frequency band used for mobile communication rises from 800 MHz to 2 GHz, free space loss decreases by about 8 dB so that the service coverage is substantially reduced to about half.

Further, antenna optimization technology is required in order to solve the problem of increasing loss, such as a decrease in a diffraction property, air, rainfall, forest, etc.

Accordingly, in order to solve the aforementioned problems, a technology is required in which a broadband antenna receives information on a frequency environment of the installation area thereof from a base station and adjusts the vertical arrangement of radiating elements thereof by itself in order to achieve optimal antenna performance in the installed frequency environment.

(Patent Document 1) Korean Patent Application No. 10-2003-0027727 (filed on Apr. 30, 2003 and entitled “Antenna system for controlling horizontal beam and vertical beam of antenna radiation pattern and control method for antenna system using same”; inventors Hyo-Jin Lee and Sang-Gi Kim; applicants LG Telecom, Ltd. and Gamma Nu, Inc.)

### SUMMARY

An aspect of the present invention is to provide an antenna equipped with vertically arranged radiating elements that can control the vertical arrangement of the radiating elements thereof.

Another aspect of the present invention is to provide an antenna equipped with vertically arranged radiating elements that can group the radiating elements on a column basis and uniformly control the vertical arrangement of the radiating elements thereof.

Another aspect of the present invention is to provide an antenna equipped with vertically arranged radiating elements that can individually control the radiating elements in the control of the vertical arrangement of the radiating elements thereof.

In accordance with one aspect of the present invention, an antenna equipped with vertically arranged radiating elements, which is connected to a base station system, includes: a reflective plate installed in the interior of the antenna; a plurality of radiating elements installed on a planar surface of the reflective plate; and a moving unit that moves the plurality of radiating elements upwards or downwards on the planar surface of the reflective plate.

The antenna may further include: an antenna state detector that detects the state of the connection with the base station system and the operating state of the antenna and creates antenna information; a radio frequency signal detector that measures the strength of a radio frequency signal currently being provided in the area where the antenna has been installed, and creates radio frequency signal information and frequency band information; a controller that creates interval control information; and an interval adjustment driving unit that adjusts the vertical intervals between the plurality of radiating elements according to the interval control information.

The interval control information may be created using service band information received from the base station system or the frequency band information.

Based on at least one of the plurality of radiating elements, the moving unit may move the remaining radiating elements upwards or downwards.

The base station antenna may move the plurality of radiating elements upwards or downwards with respect to the longitudinal center of the reflective plate.

Among the plurality of radiating elements, the radiating elements other than the uppermost or lowermost radiating element may be moved upwards or downwards.

Two or more of the plurality of radiating elements may be simultaneously moved upwards or downwards, or the radiating elements may be individually moved upwards or downwards.

The antenna equipped with vertically arranged radiating elements, according to the embodiment of the present invention, can control the vertical arrangement of the radiating elements thereof in order to adjust side-lobe among beam characteristics of the antenna, thereby achieving beam efficiency for minimizing interference between a macro base station and small base stations that are intermingled with each other.

Furthermore, even if a frequency environment around the area where the antenna has been installed changes, the antenna can adapt to the changed frequency environment in order to achieve an optimal performance by controlling the vertical arrangement of the radiating elements thereof.

### BRIEF DESCRIPTION OF THE DRAWINGS

FIG. 1 is a block diagram of an antenna that includes vertically arranged radiating elements according to an embodiment of the present invention;

FIG. 2 is a schematic diagram illustrating an exemplary structure of a moving unit of an antenna that includes vertically arranged radiating elements, according to an embodiment of the present invention; and

FIG. 3 is a schematic diagram illustrating an exemplary operation of the antenna that includes the vertically arranged radiating elements, according to an embodiment of the present invention.

### DETAILED DESCRIPTION

Hereinafter, an exemplary embodiment of the present invention will be described in detail with reference to the accompanying drawings. Although particular matters such as specific configuration elements are shown in the following description, it will be obvious to those skilled in the art to which the present invention pertains that the particular matters are provided only to help a comprehensive understanding of the present invention, and various modifications and changes can be made within the scope of the present invention.

Further, in the accompanying drawings and the following description, identical elements are provided with the same reference numeral where possible.

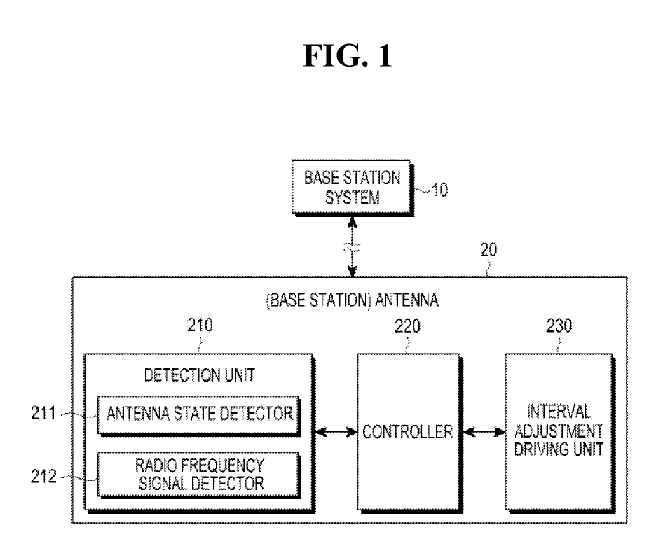

FIG. 1 is a block diagram of an antenna that includes vertically arranged radiating elements according to an embodiment of the present invention.

The antenna that includes the vertically arranged radiating elements, according to the embodiment of the present invention, is a base station antenna 20 connected to a base station system 10 equipped with broadband communication devices.

The base station system 10 refers to a wireless communication base station of a mobile communication service provider, and may be equipped with various bands of communication devices. Here, examples of the various bands include the 800 MHz band or the 900 MHz band (e.g., 698 to 960 MHz) which is a relatively low frequency band, or the 1.8 MHz band or the 2.1 GHz band (e.g., 1.7 to 2.17 GHz) or the 2.3 GHz band (e.g., 2.3 to 2.7 GHz) which is a relatively high frequency band.

The base station system 10 provides information on a service band of an area where the base station antenna 20 has been installed to a controller 220 included in the base station antenna 20, which will be described below.

The base station system 10 receives, from the base station antenna 20, antenna status information that contains information necessary for identifying whether the base station antenna 20 has been normally connected with the base station system 10 through a wired line, a wireless line, or a combination of wired and wireless lines.

The base station system 10 may receive, from the base station antenna 20, antenna status information containing information necessary for identifying whether the normally connected base station antenna 20 normally operates as a service band corresponding to a service area in the installation area thereof.

The base station antenna 20 is a broadband antenna and is always connected with the base station system 10 through a wired line, a wireless line, or a combination of wired and wireless lines.

The base station antenna 20 receives service band information of the installation area thereof from the base station system 10.

In cases where the base station antenna 20 fails to receive the service band information of the installation area thereof from the base station system 10, the base station antenna 20 acquires the service band information of the current installation area thereof by itself through a radio frequency (RF) signal detector 212 included in a detection unit 210, which will be described below.

The base station antenna 20 includes the detection unit 210 for detecting the state of the antenna, the controller 220 for controlling the antenna to operate at optimal performance, and an interval adjustment driving unit 230 for adjusting intervals between the plurality of radiating elements that are vertically arranged in the broadband antenna.

The detection unit 210 includes an antenna state detector 211 and the radio frequency signal detector 212.

The antenna state detector 211 performs functions of detecting the overall connection state and operating state of the base station antenna 20 and transferring the detection results to the controller 20. Here, the functions of detecting the connection state and the operating state may be defined as follows.

The function of detecting the connection state means a function of detecting whether the base station antenna 20 and the base station system 10 have been normally connected to each other and providing the corresponding information to the controller 220, which will be described below.

The function of detecting the operating state means a function of detecting whether the elements constituting the base station antenna 20 operate normally and providing the corresponding information to the controller 220, which will be described below.

The radio frequency signal detector 212 detects service band information currently being provided in the area where the base station antenna 20 has been installed and provides the detected information to the controller 220 which will be described below.

The base station antenna 20 measures a radio frequency (RF) signal in a service band currently being used, and provides the measured RF signal strength to the controller 220.

The controller 220 processes various types of information in order to provide a service at an optimal performance in the service band corresponding to the area where the base station antenna 20 has been installed.

In order to provide a service at optimal performance, the controller 220 receives information on the service band corresponding to the installation area from the base station system 10, and provides optimized interval adjustment control information to the interval adjustment driving unit 230 in the corresponding service band extracted from the received information.

In cases where the controller 220 fails to receive the information on the service band from the base station system 10, the controller 220 makes a request for information on a service band in which a service is currently provided through the base station antenna 20 to the radio frequency signal detector 212 included in the detection unit 210 to receive the information, and calculates optimized interval adjustment control information for the corresponding service band from the received information to provide the calculated information to the interval adjustment driving unit 230.

The interval adjustment driving unit 230 adjusts the intervals between the plurality of radiating elements, which are vertically arranged in the broadband antenna, according to the interval adjustment control information received from the controller 220.

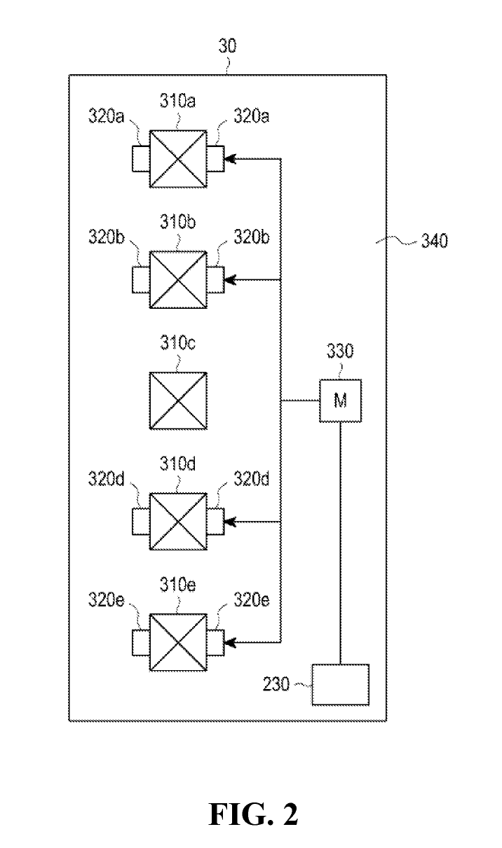

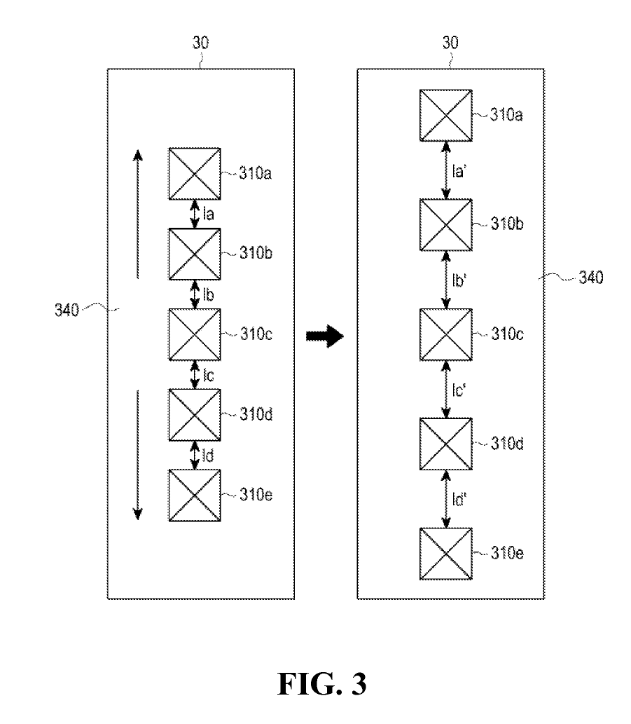

FIG. 2 is a schematic diagram illustrating an exemplary structure of a moving unit of an antenna that includes vertically arranged radiating elements, according to an embodiment of the present invention, and FIG. 3 is a schematic diagram illustrating an exemplary operation of the antenna that includes the vertically arranged radiating elements, according to an embodiment of the present invention.

Referring to FIG. 2, the moving unit 30 includes a reflective plate 340, a plurality of radiating elements 310 (310a, 310b, 310c, 310d, and 310e) vertically arranged on the reflective plate 340, moving support parts 320 (320a, 320b, 320d, and 320e) on opposite sides (e.g., the left and right sides) of the radiating elements 310a, 310b, 310d, and 310e other than the radiating element 310c which functions as a reference for the adjustment of intervals, a power generation unit 330 (e.g., a motor) for providing power for the adjustment of the intervals, and an interval adjustment driving unit 230 for controlling the power generation unit 330 according to interval adjustment control information.

The moving support parts 320 make the plurality of radiating elements 310 easily move in the vertical direction, and secure the plurality of radiating elements 310 to the reflective plate 340 when the intervals between the radiating elements are completely adjusted.

The power generation unit 330 is connected to the plurality of radiating elements 310 or the moving support parts 320 through a rack and pinion gear, a link structure, various gear connection structures, a guide and slide structure, etc. in order to provide power for interval adjustment.

The interval adjustment driving unit 230 adjusts the intervals between the plurality of radiating elements 310, which are installed in the vertical array on the reflective plate 340 of the broadband antenna, according to interval adjustment control information.

Here, as illustrated in FIG. 2, the intervals between the radiating elements 310 may increase, or may alternatively decrease.

When the intervals are adjusted, one of the plurality of radiating elements 310 is selected to be a reference, and the intervals between the radiating elements 310 may be adjusted by moving the radiating elements other than the reference up and down.

Referring to FIG. 3, when the intervals between the radiating elements are adjusted, the radiating element 310c installed in the center of the reflective plate 340 is selected to be a reference, and the remainder is categorized into the radiating elements 310a and 310b above the radiating element 310c and the radiating elements 310d and 310e below the radiating element 310c. For example, in cases where the intervals between the radiating elements 310 increase, the radiating elements 310a and 310b above the radiating element 310c, which is installed in the center of the reflective plate 340, are moved upwards, and the radiating elements 310d and 310e below the radiating element 310c are moved downwards. Here, it can be identified that the intervals 1a′, 1b′, 1c′, and 1d′ between the radiating elements after the interval adjustment are greater than the intervals 1a, 1b, 1c, and 1d between the radiating elements before the interval adjustment.

In contrast, in cases where the intervals between the radiating elements 310 decrease, the radiating elements 310a and 310b above the radiating element 310c, which is installed in the center of the reflective plate 340, are moved downwards, and the radiating elements 310d and 310e below the radiating element 310c are moved upwards.

Although the plurality of radiating elements 310 are arranged to be perpendicular to the horizontal plane with respect to the longitudinal center of the reflective plate 340 in FIGS. 2 and 3, the present invention is not limited thereto, and even if the plurality of radiating elements 310 are vertically arranged in any place of the reflective plate 340, the intervals between the radiating elements 310 may be adjusted while one of the plurality of radiating elements 310 is selected to be a reference. For example, in cases where the intervals between the radiating elements 310 increase with respect to the uppermost radiating element 310a among the radiating elements 310 installed on the reflective plate 340, the intervals between the radiating elements 310 may be increased by moving the radiating elements 310b, 310c, 310d, and 310e other than the reference radiating element 310a downwards (toward the ground). In contrast, in cases where the intervals between the radiating elements 310 are decreased with respect to the radiating element 310a, the intervals between the radiating elements 310 may be decreased by moving the radiating elements 310b, 310c, 310d, and 310e other than the reference radiating element 310a upwards.

Furthermore, in cases where the intervals between the radiating elements 310 are increased with respect to the lowermost radiating element 310e among the radiating elements 310 installed on the reflective plate 340, the intervals between the radiating elements 310 may be increased by moving the radiating elements 310a, 310b, 310c, and 310d other than the reference radiating element 310e upwards. In contrast, in cases where the intervals between the radiating elements 310 are decreased with respect to the radiating element 310e, the intervals between the radiating elements 310 may be decreased by moving the radiating elements 310a, 310b, 310c, and 310d other than the reference radiating element 310e downwards.

Also, the intervals between the radiating elements 310 may be adjusted by moving the radiating elements above a reference radiating element and the radiating elements below the reference radiating element upwards or downwards with respect to a vertical line on the reflective plate 340 in addition to the longitudinal center of the reflective plate 340. That is, the reference is not limited to the longitudinal center of the reflective plate.

Although the plurality of radiating elements 310, which are vertically arranged, are all controlled at one time in the above described method of adjusting the intervals between the radiating elements, the present invention is not limited thereto, and the intervals between the radiating elements may be adjusted by individually controlling the radiating elements, or by selecting one or more of the plurality of radiating elements 310 and then simultaneously moving the selected radiating elements upwards or downwards. This is because each radiating element can be accurately controlled according to a selection of the base station system or the controller included in the base station antenna after the intervals between the radiating elements are uniformly adjusted.

Through the interval adjustment described above, the broadband antenna can achieve the best performance in a frequency band currently being used in the area where the broadband antenna has been installed. This is because the broadband antenna can achieve performance specialized for service frequencies in a specific band as the intervals between the plurality of radiating elements 310 installed in the vertical array form in the broadband antenna are increased or decreased.

As a result, among the beam characteristics of the broadband antenna that includes the vertically arranged radiating elements, according to the present invention, side-lobe is controlled through the adjustment of the intervals between the radiating elements 310.

Although a broadband antenna, according to the related art, cannot provide an optimal service in an area having a frequency environment in which a macro base station and small base stations are intermingled with each other, the antenna that includes the vertically arranged radiating elements, according to the present invention, can enhance beam efficiency of the broadband antenna while minimizing interference between the base stations even if being installed in the area having the above-described frequency environment.

In addition, the present invention can also be applied to inter-cell interference coordination (ICIC) technology.

Although the present disclosure has been described with reference to the embodiments shown in the drawings, it should be understood by those skilled in the art that various changes and modifications may be made thereto and other embodiments equivalent thereto are possible. Accordingly, the scope of the present disclosure is not limited to the above-described embodiments and should be determined by the appended claims and their equivalents.

1. An antenna equipped with vertically arranged radiating elements, which is connected to a base station system, comprising:
a reflective plate installed in the interior of the antenna;
a plurality of radiating elements installed on a planar surface of the reflective plate; and
a moving unit that moves the plurality of radiating elements upwards or downwards on the planar surface of the reflective plate.

2. The antenna of claim 1, further comprising:
an antenna state detector that detects the state of the connection with the base station system and the operating state of the antenna and creates antenna information;
a radio frequency signal detector that measures the strength of a radio frequency signal currently being provided in the area where the antenna has been installed, and creates radio frequency signal information and frequency band information;
a controller that creates interval control information; and
an interval adjustment driving unit that adjusts the vertical intervals between the plurality of radiating elements according to the interval control information.

3. The antenna of claim 2, wherein the interval control information is created using service band information received from the base station system or the frequency band information.

4. The antenna of claim 1, wherein based on at least one of the plurality of radiating elements, the moving unit moves the remaining radiating elements upwards or downwards.

5. The antenna of claim 1, wherein the base station antenna moves the plurality of radiating elements upwards or downwards with respect to the longitudinal center of the reflective plate.

6. The antenna of claim 4, wherein among the plurality of radiating elements, the radiating elements other than the uppermost or lowermost radiating element are moved upwards or downwards.

7. The antenna of claim 4, wherein two or more of the plurality of radiating elements are simultaneously moved upwards or downwards, or the radiating elements are individually moved upwards or downwards.
